(19) United States
(12) Patent Application Publication
(10) Pub. No.: US 2017/0024048 A1
(43) Pub. Date: Jan. 26, 2017

(54) PRESSING SENSOR

(71) Applicant: Murata Manufacturing Co., Ltd., Nagaokakyo-shi (JP)

(72) Inventors: TAKASHI KIHARA, Nagaokakyo-shi (JP); Jun Endo, Nagaokakyo-shi (JP)

(21) Appl. No.: 15/285,002

(22) Filed: Oct. 4, 2016

Related U.S. Application Data
(63) Continuation of application No. PCT/JP2015/057811, filed on Mar. 17, 2015.

(30) Foreign Application Priority Data
Apr. 18, 2014 (JP) 2014-085969

(51) Int. Cl. G06F 3/041

(52) U.S. Cl. CPC G06F 3/0414; G01L 1/16

(57) ABSTRACT

A pressing sensor that includes a first substrate, a second substrate, and a piezoelectric film between the first substrate and the second substrate. A thickness of the first substrate is greater than a thickness of the second substrate.

### CROSS REFERENCE TO RELATED APPLICATIONS

The present application is a continuation of International application No. PCT/JP2015/057811, filed Mar. 17, 2015, which claims priority to Japanese Patent Application No. 2014-085969, filed Apr. 18, 2014, the entire contents of each of which are incorporated herein by reference.

### FIELD OF THE INVENTION

The present invention relates to a pressing sensor which detects a press on an operation surface such as a touch panel.

### BACKGROUND OF THE INVENTION

Electronic devices including touch panels each not only detect a touch position on an operation surface but also detect a press on the operation surface. Hence, a pressing sensor which can detect a press on the operation surface is added to the touch panel.

There are various configurations of pressing sensors, and a pressing sensor having detection electrodes of flat film shapes disposed on both surfaces of a piezoelectric film having good translucency and flexibility has been developed (see, for example, Patent Literature 1).

The piezoelectric film whose main material is polyvinylidene difluoride (PVDF) is typically known. Further, piezoelectric films whose main materials are chiral polymers such as poly-L-lactic acid (PLLA) and poly-D-lactic acid (PDLA) are also known.

Patent Document 1: International Publication No. WO2012/137897 (A1)

### SUMMARY OF THE INVENTION

Depending on a material of the detection electrodes, directly bonding the detection electrodes to the piezoelectric film of the above-described material requires processing such as heating, which undermines piezoelectricity of the piezoelectric film. Hence, the applicant has developed a pressing sensor employing a configuration where the detection electrodes are provided on a flexible substrate and the flexible substrate is bent to sandwich the piezoelectric film. The pressing sensor adopts a multilayer structure formed by stacking a first flexible substrate, the piezoelectric film and a second flexible substrate in order. When the flexible substrate on one side is pressed, the piezoelectric film deflects and stretches. Thus, electric charges are produced on the surface of the piezoelectric film and electrical signals are produced in the detection electrodes. The pressing sensor adopts such a multilayer structure, so that it is possible to freely set a combination of materials of the piezoelectric film and the detection electrodes.

In this regard, the pressing sensor adopts the multilayer structure and therefore becomes thick, and an arrangement of the pressing sensor in an electronic device or the like is significantly restricted. Hence, it is preferable to use a thin flexible substrate to decrease the thickness of the pressing sensor. However, in this case, press detection sensitivity of the pressing sensor tends to deteriorate, and it is difficult to provide good detection sensitivity while decreasing the entire thickness of the pressing sensor.

It is therefore an object of the present invention to provide a pressing sensor which provides good detection sensitivity while decreasing the entire thickness of the pressing sensor.

The present invention is directed towards a pressing sensor which includes a first substrate which expands along a first principal surface; a second substrate which expands along a second principal surface; and a piezoelectric film which is stacked between the first substrate and the second substrate, and in which a thickness of the first substrate is thicker than a thickness of the second substrate.

When the pressing sensor receives a press and deflects, the first substrate, the piezoelectric film and the second substrate stretch in in-plane directions of the first principal surface and the second principal surface. In this case, by making the thickness of the first substrate thick and the thickness of the second substrate thin, it is possible to increase a stretch of the piezoelectric film while decreasing the thickness of the pressing sensor.

Preferably, the first substrate includes a first detection electrode, and the second substrate includes a second detection electrode. Consequently, it is possible to arbitrarily set a combination of materials of the piezoelectric film and the detection electrode without undermining piezoelectricity of the piezoelectric film.

Preferably, the pressing sensor further includes a first sticking member which sticks the piezoelectric film and the first substrate; and a second sticking member which sticks the piezoelectric film and the second substrate. By so doing, it is possible to quickly and easily stick the first substrate and the second substrate to the piezoelectric film. Further, a stress produced by a press can be effectively transmitted from the first substrate to the piezoelectric film.

Preferably, the first sticking member is made of an adhesive which is solidified by a chemical reaction. Further, a stress produced by the press can be effectively transmitted from the first substrate to the piezoelectric film.

Alternatively, the first sticking member and the second sticking member may be pressure sensitive adhesives having viscosity. In this case, preferably, the thickness of the first sticking member is thinner than the thickness of the second sticking member. Even in this case, the stress produced by the press can be effectively transmitted from the first substrate to the piezoelectric film.

Preferably, the first substrate is a rigid substrate, and the second substrate is a flexible substrate. The rigid substrate includes a paper phenol substrate, an alumina substrate, an epoxy substrate and a low-temperature co-fired ceramic substrate which are generally low-cost compared to flexible substrates. Further, the flexible substrate can be easily bent, and combining the rigid substrate and the flexible substrate facilitates wiring connection of the first detection electrode and the second detection electrode.

Preferably, the piezoelectric film has a principal surface shape including four sides orthogonal to each other, and is made of a chiral polymer as a main material oriented along a direction crossing the four sides. Preferably, the chiral polymer in particular is oriented in a direction of approximately 45° with respect to the four sides.

According to this configuration, the piezoelectric film whose main material is a chiral polymer includes piezoelectric tensor components (expressed as d14 when a film thickness direction is a first axis and a film stretching direction is a third axis) for detecting a press in the film thickness direction, and does not have pyroelectricity. Consequently, it is possible to obtain an output without being influenced by a temperature change at a detection position.

According to the present invention, it is possible to increase a stretch of a piezoelectric film and, consequently, provide good detection sensitivity while suppressing the entire thickness of the pressing sensor.

### BRIEF EXPLANATION OF THE DRAWINGS

FIGS. 1(A) and 1(B) illustrate a plan view and a side view of an electronic device including a pressing sensor according to a first embodiment of the present invention.

FIGS. 2(A) to 2(D) illustrate a plan view and side sectional views of a pressing sensor according to the first embodiment of the present invention.

FIGS. 3(A) and 3(B) illustrate a schematic view illustrating a deflection and a stretch occurring during a press on the pressing sensor according to the first embodiment of the present invention.

FIG. 4 illustrates a side sectional view of a pressing sensor according to a second embodiment of the present invention.

FIG. 5 illustrates a side sectional view of a pressing sensor according to a third embodiment of the present invention.

### DETAILED DESCRIPTION OF THE INVENTION

A pressing sensor according to embodiments of the present invention will be described below.

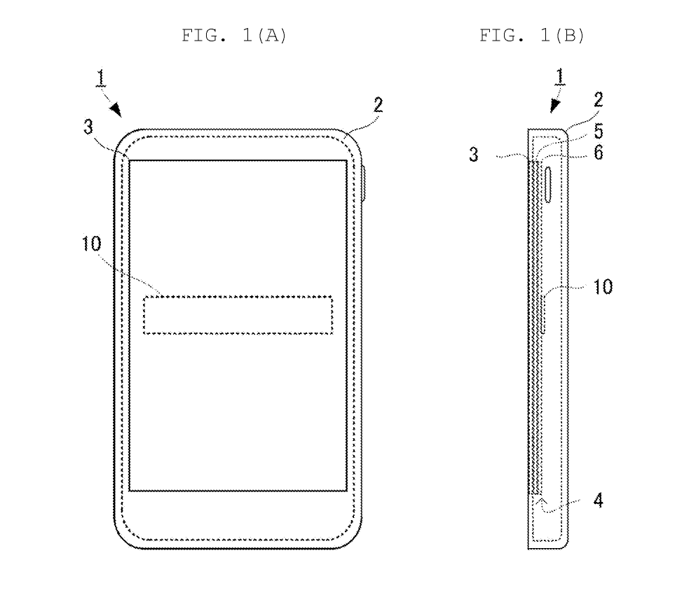

FIG. 1(A) is a plan view of an electronic device 1 having a built-in pressing sensor 10 according to the first embodiment of the present invention. FIG. 1(B) is a side view of the electronic device 1.

Although not limited to any specific electronic device, the electronic device 1 described herein is a smartphone terminal, and has functions such as music playback and voice communication. The electronic device 1 includes an exterior body 2, a cover glass 3 and a touch panel 4. In addition, although not illustrated, the electronic device 1 includes other hardware such as a CPU, a storage unit, a wireless communication circuit, an image processing circuit, a voice processing circuit and a circuit substrate composing the smartphone terminal.

The exterior body 2 has a box shape whose length and width are larger than the thickness and whose front surface is opened, and includes an internal space. The exterior body 2 is made of a generally hard organic material such as ABS or PC, and is configured to be dividable at optional positions. The cover glass 3 has translucency, and is fitted to an opening portion of the exterior body 2 to close the internal space of the exterior body 2.

The touch panel 4 is in close contact with a back surface side of the cover glass 3, and is housed in the internal space of the exterior body 2. When an arbitrary position of the cover glass 3 is pressed by a finger or the like, the touch panel 4 deforms integrally with the cover glass 3. The touch panel 4 includes an electrostatic sensor 5, a display unit 6 and the pressing sensor 10. The electrostatic sensor 5, the display unit 6 and the pressing sensor 10 are disposed in this order from the side of the cover glass 3. The electrostatic sensor 5 has a structure that includes capacitance detection electrodes on both principal surfaces of a dielectric substrate, faces the cover glass 3 and produces a local capacitance change in response to a user's touch operation on the cover glass 3. The display unit 6 is a liquid crystal display panel or an organic EL display panel, and draws images on the cover glass 3 as a display surface. The pressing sensor 10 deforms integrally with the cover glass 3 when a user's finger presses the cover glass 3. The pressing sensor 10 has a strip shape when seen from a front view, and is disposed to extend in a width direction of the exterior body 2. In addition, the pressing sensor 10 may be disposed to extend in a length direction of the exterior body 2.

In this electronic device 1, the electrostatic sensor 5 detects a user's touch operation on the cover glass 3, and the pressing sensor 10 detects a user's pressing operation on the cover glass 3 to perform a response operation corresponding to each.

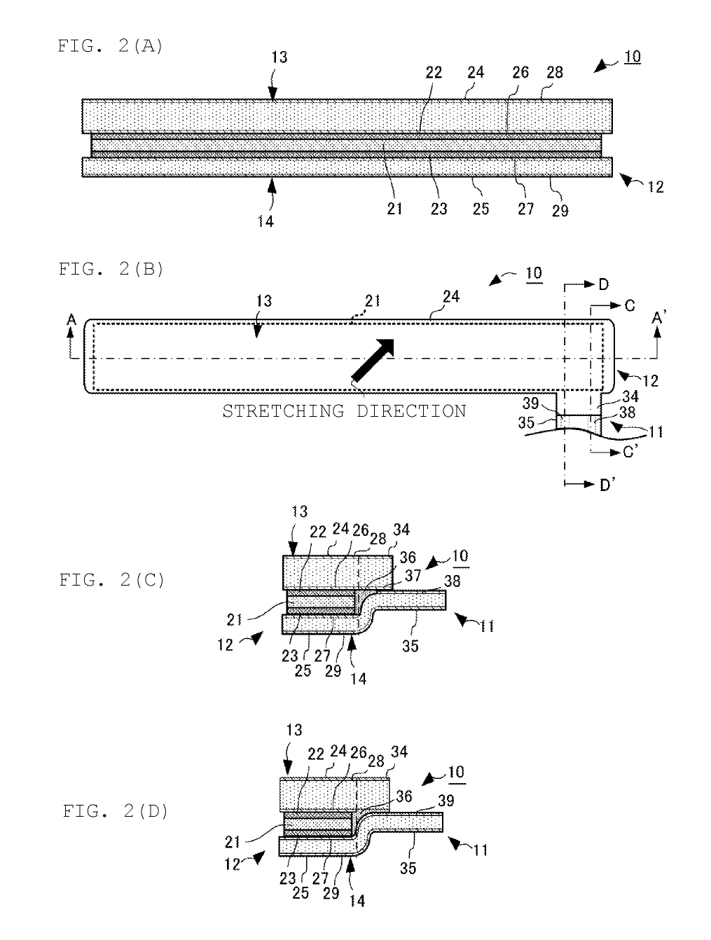

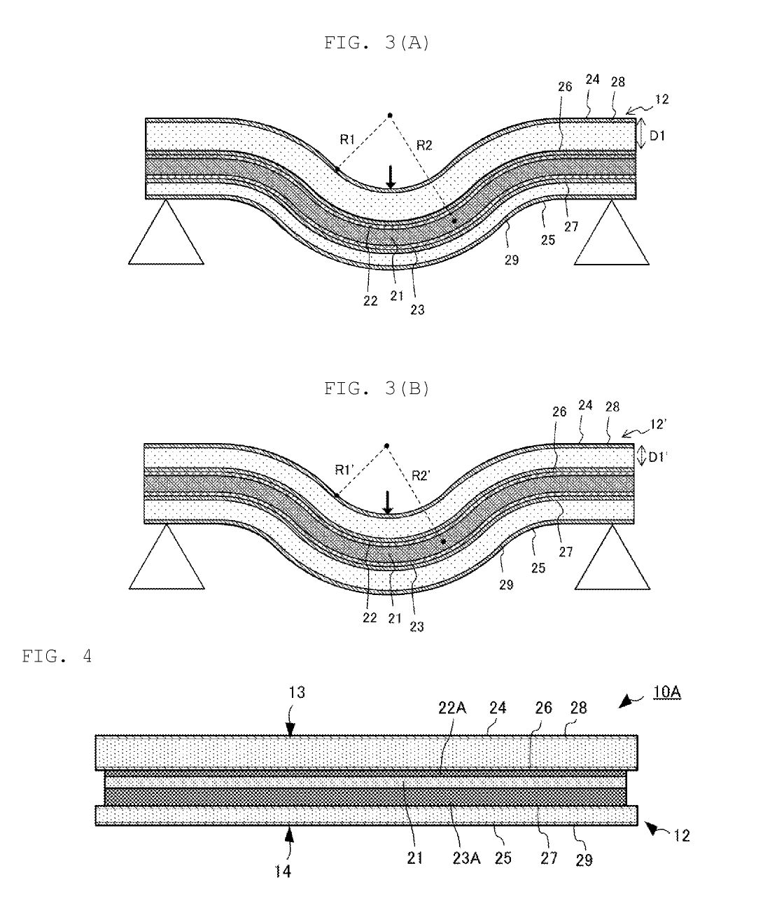

FIG. 2(A) is a side sectional view of the pressing sensor 10, and illustrates a cross section passing a position indicated by A-A′ in FIG. 2(B). FIG. 2(B) is a plan view of the pressing sensor 10. FIG. 2(C) is a side sectional view of the pressing sensor 10, and illustrates a cross section passing a position indicated by C-C′ in FIG. 2(B). FIG. 2(D) is a side sectional view of the pressing sensor 10, and illustrates a cross section passing a position indicated by D-D′ in FIG. 2(B).

The pressing sensor 10 includes a wiring portion 11 and a sensor unit 12. The sensor unit 12 is a unit which detects a press, and has a strip shape whose horizontal direction is a longitudinal direction and whose vertical direction is a lateral direction in FIG. 2(B). The wiring portion 11 is a unit which establishes wire connection with the sensor unit 12, and extends in the vertical direction in FIG. 2(B), i.e., the lateral direction of the sensor unit 12 from a side surface extending in the longitudinal direction of the sensor unit 12.

The sensor unit 12 includes a first principal surface 13 which is directed upward in FIG. 2(A), and a second principal surface 14 which is directed downward in FIG. 2(A). The sensor unit 12 adopts a multilayer structure including a first substrate 24, a first sticking member 22, a piezoelectric film 21, a second sticking member 23, and a second substrate 25. The first substrate 24, the first sticking member 22, the piezoelectric film 21, the second sticking member 23 and the second substrate 25 have flat film shapes, are aligned in order in a thickness direction of the pressing sensor 10 and are stacked from the first principal surface 13 to the second principal surface 14.

The first substrate 24 defines the first principal surface 13 and expands along the first principal surface 13. The first substrate 24 is a rigid substrate such as a paper phenol substrate, an alumina substrate, an epoxy substrate and a low-temperature co-fired ceramic substrate, and includes a first detection electrode 26 and a first shield electrode 28. The first shield electrode 28 is made of a general electrode material such as a copper foil, and is provided to cover an entire surface of the first substrate 24 at the side of the first principal surface 13. The first shield electrode 28 is connected to a ground potential, and shields the pressing sensor 10 from electromagnetic waves. The first detection electrode 26 is made of a general electrode material such as a copper foil, and is provided to cover an entire surface of the first substrate 24 at the side of the second principal surface 14.

The second substrate 25 defines the second principal surface 14, and expands along the second principal surface 14. The second substrate 25 is a flexible substrate made of polyethylene terephthalate (PET) resin, and includes a second detection electrode 27 and a second shield electrode 29. The second shield electrode 29 is made of a general electrode material such as a copper foil, and is provided to cover the entire surface of the second substrate 25 at the side of the second principal surface 14. The second shield electrode 29 is connected to a ground potential, and shields the pressing sensor 10 from electromagnetic waves. The second detection electrode 27 is made of a general electrode material such as a copper foil, and is provided to cover an entire surface of the second substrate 25 at the side of the first principal surface 13.

The first sticking member 22 is stuck to a surface of the first substrate 24 at the side of the second principal surface 14 and a surface of the piezoelectric film 21 at the side of the first principal surface 13, respectively, to paste the first substrate 24 and the piezoelectric film 21. The first sticking member 22 is made of an adhesive which is solidified (phase-changes) from a liquid to a solid by a chemical reaction to produce a sticking force. This solidified adhesive has a relatively strong sticking force and is made of a relatively hard material among materials which can be used as sticking members. Thus, the first sticking member 22 is made of the relatively hard material and, consequently, can effectively transmit a stress produced by a press, from the first substrate 24 to the piezoelectric film 21.

The second sticking member 23 is stuck to a surface of the second substrate 25 at the side of the first principal surface 13 and a surface of the piezoelectric film 21 at the side of the second principal surface 14, respectively, to paste the second substrate 25 and the piezoelectric film 21. The second sticking member 23 is made of the same adhesive as that of the first sticking member 22.

The first sticking member 22 and the second sticking member 23 are made of a material of a relatively strong sticking force. Consequently, it is possible to provide a sufficient strength even when the thicknesses of the first sticking member 22 and the second sticking member 23 are thin, and make the first sticking member 22 and the second sticking member 23 thin and make the sensor unit 12 entirely thin.

In addition, the first sticking member 22 and the second sticking member 23 may be made of a material different from the adhesive which is solidified by a chemical reaction.

The piezoelectric film 21 is made of PLLA (poly-L-lactic acid) having piezoelectricity. The piezoelectric film 21 is stacked between the first substrate 24 and the second substrate 25, and is stuck to the first substrate 24 and the second substrate 25 with the first sticking member 22 or the second sticking member 23 interposed therebetween. The PLLA has a piezoelectric constant (shear piezoelectric constant) expressed as d14 when a stretching direction is a triaxial direction and directions vertical to the triaxial direction are a uniaxial direction and a biaxial direction. Further, the piezoelectric film 21 is cut in a strip shape such that the uniaxial direction of the PLLA is the thickness direction and directions forming angles of 45° with respect to the triaxial direction (stretching direction) are the longitudinal direction and the lateral direction.

When the sensor unit 12 receives the press in the thickness direction from the side of the first principal surface 13 and deflects in the thickness direction, the stress produced by this deflection is transmitted from the first substrate 24 to the piezoelectric film 21 via the first sticking member 22 and the piezoelectric film 21 stretches in the longitudinal direction. Then, the piezoelectric film 21 polarizes in the thickness direction to produce electric charges in the surfaces of the piezoelectric film 21 at the side of the first principal surface 13 and at the side of the second principal surface 14. Electrostatic induction in response to these electric charges produces a potential difference corresponding to a stretch amount of the piezoelectric film 21 in the longitudinal direction, in the first detection electrode 26 and the second detection electrode 27.

The wiring portion 11 includes a first substrate protruding portion 34, a second substrate extended portion 35 and an adhesive portion 36. The first substrate protruding portion 34 includes a wiring electrode 37. The second substrate extended portion 35 includes a wiring electrode 38 and a wiring electrode 39.

As illustrated in FIG. 2(B), the first substrate protruding portion 34 protrudes from the first substrate 24 by a predetermined length in the lateral direction of the sensor unit 12. The second substrate extended portion 35 faces the first substrate protruding portion 34, and extends from the second substrate 25 along in the lateral direction of the sensor unit 12 compared to the first substrate protruding portion 34. An electronic part such as an IC and an external connection connector are mounted at an end of the second substrate extended portion 35 which is not illustrated.

As illustrated in FIGS. 2(C) and 2(D), the first substrate protruding portion 34 is composed of a rigid substrate similar to the first substrate 24. The second substrate extended portion 35 is composed of a flexible substrate similar to the second substrate 25, and is bent toward the side of the first principal surface 13 so as to contact the first substrate protruding portion 34 near a connecting portion of the sensor unit 12 and the wiring portion 11. The adhesive portion 36 adheres the second substrate extended portion 35 of a bent state to the first substrate protruding portion 34.

The wiring electrode 37 of the first substrate protruding portion 34 includes one end which is connected to the first detection electrode 26 of the sensor unit 12, and the other end which is exposed to a surface of the first substrate protruding portion 34 at the side of the second principal surface 14. The wiring electrode 38 of the second substrate extended portion 35 includes one end which is in contact with the wiring electrode 37 of the first substrate protruding portion 34 to connect to the first detection electrode 26 with the wiring electrode 37 interposed therebetween, and the other end which is connected to an electronic part such as an IC and an external connection connector which are mounted on the second substrate extended portion 35 and are not illustrated. The wiring electrode 39 of the second substrate extended portion 35 includes one end which is connected to the second detection electrode 27 of the sensor unit 12, and the other end which is connected to an electronic part and an external connection connector which are mounted on the second substrate extended portion 35 and are not illustrated.

The electronic part such as the IC which is not illustrated converts a potential difference between the first detection electrode 26 and the second detection electrode 27 into a voltage, and outputs a detection signal via the external connection connector which is not illustrated. The second substrate extended portion 35 is composed of a flexible substrate which can be easily bent. Consequently, it is possible to easily establish wiring connection of the first substrate 24 which is composed of the rigid substrate with the first detection electrode 26.

The pressing sensor 10 employing such a configuration has difficulty in forming the first detection electrode 26 and the second detection electrode 27 made of copper foils on the surface of the piezoelectric film 21 made of a PLLA without undermining piezoelectricity. Hence, the copper foils to be formed as the first detection electrode 26 and the second detection electrode 27 are formed on the first substrate 24 and the second substrate 25 made of a material which allows good film formation of the copper foils, and are indirectly stuck to the piezoelectric film 21 with the first sticking member 22 or the second sticking member 23 interposed therebetween. Hence, a combination of the copper foils and the PLLA makes it possible to stick the first detection electrode 26 and the second detection electrode 27 to the piezoelectric film 21 without undermining piezoelectricity. That is, it is possible to arbitrarily set a combination of materials of the first detection electrode 26, the second detection electrode 27 and the piezoelectric film 21. In addition, the material of the piezoelectric film 21 can be set without being limited to the PLLA, and the materials of the first detection electrode 26 and the second detection electrode 27 can also be set without being limited to the copper foils.

Further, the piezoelectric film 21 whose main material is PLLA is chiral polymers whose PLLA has flexibility. Consequently, it is possible to reliably detect a displacement amount without causing a damage unlike piezoelectric ceramics even when significant displacement occurs. Further, the PLLA has a main chain which adopts a spiral structure and has piezoelectricity when molecules are oriented, and a piezoelectric constant belongs to a group of high piezoelectric constants among polymers. The PLLA produces piezoelectricity by molecule orientation processing such as uniaxial stretching, and does not need to be subjected to polling processing unlike other polymers such as PVDF or piezoelectric ceramics. That is, the piezoelectricity of the PLLA which does not belong to ferroelectrics is exhibited not by ion polarization unlike PVDF or PZT belonging to ferroelectrics, but derives from a spiral structure which is a characteristic structure of molecules. Further, the PLLA does not exhibit pyroelectricity unlike other ferroelectric piezoelectric bodies. Furthermore, although PVDF fluctuates in piezoelectric constant with time and the piezoelectric constant significantly lowers in some cases, a piezoelectric constant of the PLLA is very stable over time.

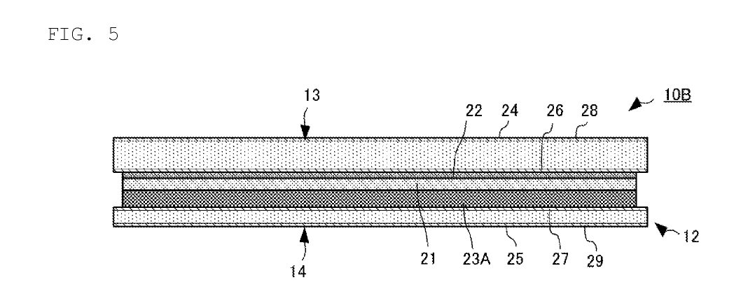

FIGS. 3(A) and 3(B) are schematic side sectional views for explaining a deflection and a stretch of the sensor unit 12 caused by a press. FIG. 3(A) illustrates a schematic configuration of the sensor unit 12 whose first substrate 24 is made thicker than the second substrate 25 in the pressing sensor 10 according to the present embodiment. FIG. 3(B) illustrates a schematic configuration of a sensor unit 12′ whose entire thickness and whose thickness of the piezoelectric film 21 are the same as those of the sensor unit 12 and which is a comparison target whose thicknesses of the first substrate 24 and the second substrate 25 are the same.

The sensor unit 12 and the sensor unit 12′ are assembled in the electronic device 1 illustrated in FIG. 1 to receive a press in the thickness direction from the side of the first principal surface 13. Hence, when the sensor unit 12 and the sensor unit 12′ are pressed, the first principal surface 13 is pushed in the thickness direction. Thus, the first substrate 24, the first sticking member 22, the piezoelectric film 21, the second sticking member 23 and the second substrate 25 deflect and stretch in the longitudinal direction. Further, the piezoelectric film 21 produces electric charges corresponding to a stretch amount in the longitudinal direction.

In this regard, assume that a push amount of the first principal surface 13 produced by a press is the same in the sensor unit 12 and the sensor unit 12′, and a curvature radius R1 of a deflection of the first principal surface 13 of the sensor unit 12, and a curvature radius R1′ of a deflection of the first principal surface 13 of the sensor unit 12′ are the same. Further, assume that the thicknesses of the first substrate 24, the first sticking member 22, the piezoelectric film 21, the second sticking member 23 and the second substrate 25 do not change in response to the push.

The first substrate 24 is thicker than the second substrate 25 in the sensor unit 12. The curvature radius R2 of the deflection of the piezoelectric film 21 (a center of the piezoelectric film 21 in the thickness direction) is larger than a curvature radius R2′ of a deflection of the piezoelectric film 21 (a center of the piezoelectric film 21 in the thickness direction) in the sensor unit 12′. More specifically, the curvature radius R2 is larger than the curvature radius R2′ by a difference between a thickness D1 of the first substrate 24 in the sensor unit 12 and a thickness D1′ of the first substrate 24 of the sensor unit 12′. The stretch amount of the piezoelectric film 21 in the longitudinal direction corresponds to the curvature radii R2 and R2′. That is, when the curvature radii R2 and R2′ are larger, the piezoelectric film 21 also significantly stretches in the longitudinal direction, and, when the curvature radii R2 and R2′ are small, the piezoelectric film 21 stretches a little in the longitudinal direction.

Consequently, the pressing sensor 10 according to the embodiment of the present invention includes the sensor unit 12 whose thickness of the first substrate 24 is thicker than the thickness of the second substrate 25. Hence, it is possible to increase the curvature radius of deflection of the piezoelectric film 21 and the stretch of the piezoelectric film 21 in the longitudinal direction caused by a press compared to a comparative configuration where the first substrate 24 and the second substrate 25 have the same thickness. Consequently, the pressing sensor 10 can provide good detection sensitivity. Further, the thickness of the second substrate 25 is thinner than the thickness of the first substrate 24, so that it is possible to suppress the entire thickness of the sensor unit 12.

Furthermore, in the pressing sensor 10 according to the embodiment of the present invention, the second substrate 25 of the sensor unit 12 is thin, so that the second substrate 25 is likely to stretch in the longitudinal direction. Then, it is suppressed (alleviated) that the second substrate 25 constrains shape change of the piezoelectric film 21. Consequently, this can increase the stretch of the piezoelectric film 21 in the longitudinal direction.

FIG. 4 is a side sectional view of a sensor unit 12 of a pressing sensor 10A according to a second embodiment of the present invention.

The pressing sensor 10A includes a first principal surface 13 and a second principal surface 14. Further, the pressing sensor 10A adopts a multilayer structure including a first substrate 24, a first sticking member 22A, a piezoelectric film 21, a second sticking member 23A, and a second substrate 25. The first substrate 24, the piezoelectric film 21 and the second substrate 25 employ the same configurations as those of the first embodiment.

The first sticking member 22A and the second sticking member 23A are pressure sensitive adhesive sheets of different thicknesses, and the thickness of the first sticking member 22A is thinner than the thickness of the second sticking member 23A. The first sticking member 22A and the second sticking member 23A which are composed of the pressure sensitive adhesive sheets have sticking forces produced by viscosity in a wet state, and provide an advantage that it is possible to precisely adjust the thickness compared to an adhesive.

The pressing sensor 10A according to the present embodiment includes the first sticking member 22A and the second sticking member 23A composed of the pressure sensitive adhesive sheets to make the entire thickness uniform and suppress product variations of the thickness. The thicknesses of the first sticking member 22A and the second sticking member 23A are factors which influence a potential difference produced between a first detection electrode 26 and a second detection electrode 27. The first sticking member 22A and the second sticking member 23A have the predetermined thicknesses, so that this pressing sensor 10A can suppress characteristics variations of press detection.

Further, the pressure sensitive adhesive sheet is made of a softer material than the adhesive described in the previous embodiment. By using the pressure sensitive adhesive sheet as the second sticking member 23A, it is possible to prevent the second sticking member 23A from constraining shape deformation of the piezoelectric film 21 compared to a case where an adhesive is used. This makes the piezoelectric film 21 further stretch in the longitudinal direction.

In this regard, the pressure sensitive adhesive sheet whose material is relatively soft is also used for the first sticking member 22A. Therefore, there is a concern that a stress transmitted from the first substrate 24 to the piezoelectric film 21 produced by the press is suppressed by deformation of the first sticking member 22A. Hence, in this pressing sensor 10A, the thickness of the first sticking member 22A is made thinner than the thickness of the second sticking member 23A. Consequently, a decrease in the stress transmitted from the first substrate 24 to the piezoelectric film 21 via the first sticking member 22A is suppressed. Consequently, the pressing sensor 10A according to the present embodiment can increase a stretch of the piezoelectric film 21 in the longitudinal direction and provide high detection sensitivity for a push amount.

FIG. 5 is a side sectional view of a sensor unit 12 of a pressing sensor 10B according to a third embodiment of the present invention.

The pressing sensor 10B includes a first principal surface 13 and a second principal surface 14. Further, the pressing sensor 10B adopts a multilayer structure including a first substrate 24, a first sticking member 22, a piezoelectric film 21, a second sticking member 23A and a second substrate 25. The first substrate 24, the piezoelectric film 21 and the second substrate 25 employ the same configurations as those of the first embodiment.

The first sticking member 22 is composed of the same adhesive as that of the first embodiment. The second sticking member 23A is the same pressure sensitive adhesive sheet as that of the second embodiment. Even this configuration uses the pressure sensitive adhesive sheet for the second sticking member 23A and, consequently, can suppress thickness variations and characteristics variations. Further, the pressure sensitive adhesive sheet is made of a material softer than the adhesive. Consequently, it is possible to prevent the second sticking member 23A from constraining shape deformation of the piezoelectric film 21. Further, the adhesive is made of a material harder than the pressure sensitive adhesive sheet. Consequently, a decrease in a stress transmitted from the first substrate 24 to the piezoelectric film 21 via the first sticking member 22 is suppressed. Hence, the pressing sensor 10B according to the present embodiment can naturally provide high detection sensitivity for a push amount.

As described in each of the embodiments, the present invention can be carried out. However, the present invention is not limited to the above-described embodiments and can be carried out even if the present invention employs any configuration as long as the configuration corresponds to the recitations of the claims.

For example, in the first embodiment described with reference to FIG. 1, a pressing sensor 10 is disposed at a center position of an electronic device 1 (and a cover glass 3, an electrostatic sensor 5 and a display unit 6) in a longitudinal direction when seen from a plan view. By disposing the pressing sensor 10 at such a position, it is possible to provide an advantage that deflection is likely to occur compared to a position at an outside in the longitudinal direction and the pressing sensor 10 can easily detect a press in response to a lighter pressing force. However, a placement position of the pressing sensor according to the present invention is not limited to this, and, even when the pressing sensor is disposed at a different position, the pressing sensor can function in the same way as that of the first embodiment.

Further, in the first embodiment described with reference to FIG. 1, the one pressing sensor 10 is disposed in the electronic device. However, a plurality of pressing sensors according to the present invention may be disposed at different positions on an operation surface to oppose to each other. In such a case, by using a combination of detection signals of a plurality of pressing sensors, it is possible to reduce press detection variations resulting from pressing positions on the operation surface.

For example, in the first embodiment described with reference to FIG. 1, the pressing sensor 10 is formed in a strip shape extending in a direction orthogonal to the longitudinal direction of the cover glass 3, the electrostatic sensor 5 and the display unit 6. However, the pressing sensor according to the present invention is not limited to this shape, and can have arbitrary shapes. For example, an area of the pressing sensor seen from a plan view may be the same as an area of the display unit 6 seen from a plan view, and the pressing sensor may be disposed such that the outer shape of the pressing sensor overlaps the outer shape of the display unit 6. In such a case, too, it is possible to reduce press detection variations resulting from pressing positions on the operation surface.

### DESCRIPTION OF REFERENCE SYMBOLS

1: ELECTRONIC DEVICE

2: EXTERIOR BODY

3: COVER GLASS

4: TOUCH PANEL

5: ELECTROSTATIC SENSOR

6: DISPLAY UNIT

10, 10A, 10B: PRESSING SENSOR

11: WIRING PORTION

12: SENSOR UNIT

13: FIRST PRINCIPAL SURFACE

14: SECOND PRINCIPAL SURFACE

21: PIEZOELECTRIC FILM

22, 22A, 22B: FIRST STICKING MEMBER

23, 23A, 23B: SECOND STICKING MEMBER

24: FIRST SUBSTRATE

25: SECOND SUBSTRATE

26: FIRST DETECTION ELECTRODE

27: SECOND DETECTION ELECTRODE

28: FIRST SHIELD ELECTRODE

29: SECOND SHIELD ELECTRODE

34: FIRST SUBSTRATE PROTRUDING PORTION

35: SECOND SUBSTRATE EXTENDED PORTION

36: ADHESIVE PORTION

37, 38, 39: WIRING ELECTRODE

1. A pressing sensor comprising:
a first substrate having a first thickness;
a second substrate having a second thickness; and
a piezoelectric film between the first substrate and the second substrate,
wherein the first thickness is greater than the second thickness.

2. The pressing sensor according to claim 1, wherein the first substrate includes a first detection electrode, and the second substrate includes a second detection electrode.

3. The pressing sensor according to claim 2, wherein the first detection electrode is between the first substrate and the piezoelectric film, and the second detection electrode is between the second substrate and the piezoelectric film.

4. The pressing sensor according to claim 2, further comprising:
a first sticking member between the piezoelectric film and the first substrate; and
a second sticking member between the piezoelectric film and the second substrate.

5. The pressing sensor according to claim 4, wherein the first sticking member is an adhesive which is solidified by a chemical reaction.

6. The pressing sensor according to claim 5, wherein the second sticking member is a pressure sensitive adhesive having viscosity.

7. The pressing sensor according to claim 4, wherein
the first sticking member and the second sticking member are pressure sensitive adhesives having viscosity, and
a thickness of the first sticking member is less than a thickness of the second sticking member.

8. The pressing sensor according to claim 1, further comprising:
a first sticking member between the piezoelectric film and the first substrate; and
a second sticking member between the piezoelectric film and the second substrate.

9. The pressing sensor according to claim 8, wherein the first sticking member is an adhesive which is solidified by a chemical reaction.

10. The pressing sensor according to claim 9, wherein the second sticking member is a pressure sensitive adhesive having viscosity.

11. The pressing sensor according to claim 8, wherein
the first sticking member and the second sticking member are pressure sensitive adhesives having viscosity, and
a thickness of the first sticking member is less than a thickness of the second sticking member.

12. The pressing sensor according to claim 1, wherein the first substrate is made of a material more rigid than a material of the second substrate.

13. The pressing sensor according to claim 12, wherein the material of the first substrate is selected from the group consisting of paper phenol, alumina, epoxy substrate and ceramic.

14. The pressing sensor according to claim 13, wherein the material of the second substrate is polyethylene terephthalate.

15. The pressing sensor according to claim 1, wherein the piezoelectric film is made of a chiral polymer.

16. The pressing sensor according to claim 15, wherein the piezoelectric film has a planar shape and includes four sides orthogonal to each other, and is oriented along a direction crossing the four sides.

17. The pressing sensor according to claim 16, wherein the piezoelectric film is oriented in a direction of 45° with respect to the four sides.
